(19) United States
(12) Patent Application Publication
(10) Pub. No.: US 2004/0078471 A1
(43) Pub. Date: Apr. 22, 2004

(54) Apparatus, method, and computer program product for building virtual networks

(75) Inventor: Guanghong Yang, San Jose, CA (US)

Correspondence Address: Patent Law Offices of Michael E. Woods, 89 Corte Cayuga, Greenbrae, CA, 94904-1307, US

(73) Assignee: Collatus Corporation, a Delaware Corportion

(21) Appl. No.: 10/653,638

(22) Filed: Sep. 2, 2003

Related U.S. Application Data
(60) Provisional application No. 60/419,394, filed on Oct. 18, 2002.

(51) Int. Cl. G06F 15/16

(52) U.S. Cl. 709/227

(57) ABSTRACT

Disclosed is a system, method and computer program product for building virtual networks for TCP/IP networking. The system includes a global area network coupled to one or more virtual network hosting servers; and a first computing system coupled to the one or more servers though a first firewall, wherein a virtual network including the first computing system is formed with a second computing system coupled to the one or more servers through a second firewall such that the computing systems communicate with each other through a direct logical connection. The method for forming a virtual network includes a) establishing a physical connection between a first computing system through a first firewall to a virtual network hosting server coupled to a global area network; b) communicating with a second computing system physically connected to the virtual network hosting server through a second firewall, wherein the communicating step includes communicating through a direct logical connection between the computing systems. The computer program product having a computer readable medium carrying program instructions for forming a virtual network when executed using two or more computing systems each coupled to a global area network through a firewall, the executed program instructions executing a method, the method including a) establishing a physical connection between a first computing system through a first firewall to a virtual network hosting server coupled to a global area network; b) establishing a physical connection between a second computing system through a second firewall to the virtual network hosting server; and c) establishing a logical connection between the computing systems to form the virtual network.

### BACKGROUND OF THE INVENTION

The present invention relates generally to communications over computer networks and more particularly, to systems and methods for building virtual networks on top of global area computer networks, such as, for example, the Internet.

As an interdependency between businesses in the Internet economy increases, enterprises rely heavily on communication with business partners, suppliers, and customers to conduct business operations successfully and expeditiously.

However, most enterprise networks today are protected by one or more security features, including firewalls. Firewalls help these enterprises increase control over the underlying data, which can increase their business privacy. The wide use of firewalls to partition off private networks from public networks contributes to solving a potential shortage of IPv4 addresses. As a side effect, firewalls split the whole Internet into many not-fully-bi-directionally-connected network islands. Connectivity between enterprises on these islands becomes problematic.

FIG. 1 is a schematic block diagram of a network system 100 divided into a plurality of “network islands” 105ᵢ. Each island 105ᵢ includes a firewall 110ᵢ and a plurality of computing systems (e.g., a server 115ᵢ, a desktop 120ᵢ and a laptop 125ᵢ). While each firewall 110ᵢ is often configured differently from other firewalls 110ᵢ, they each limit full bi-directional data flow. As shown in FIG. 1, each computing system that is behind firewall 110₁ is not freely accessible from another computing system that is behind firewall 110₂, although both of them have connections toward public Internet 130.

Besides firewall 110 filtering/blocking features, a major reason for the connectivity problem between computing systems behind different firewalls 110ᵢ is the different private address spaces they use. Firewall 110₁ and firewall 110₂ help to define different address spaces for the individual islands 105₁ and 105₂, respectively. In actuality, this isolates different private areas among the public Internet. By applying NAT (Network Address Translation), each computing system of each island 105ᵢ is able to access Internet 130, but will lose any IP connectivity into computing systems within each island 105ᵢ, unless special administration is used in cooperation with firewalls 110ᵢ.

What is needed is a way to solve this connectivity problem, and particularly to provide systems and methods to build virtual networks for TCP/IP networking to enable computing systems of different network islands to interconnect and cooperate. Additionally, to provide a system and method for existing TCP/IP based applications to be seamlessly extended onto different network islands, with that extension to be setup dynamically across network island boundaries.

### SUMMARY OF THE INVENTION

Disclosed is a system, method and computer program product for building virtual networks for TCP/IP networking. The system includes a global area network coupled to one or more virtual network hosting servers; and a first computing system coupled to the one or more servers though a first firewall, wherein a virtual network including the first computing system is formed with a second computing system coupled to the one or more servers through a second firewall such that the computing systems communicate with each other through a direct logical connection. The method for forming a virtual network includes a) establishing a physical connection between a first computing system through a first firewall to a virtual network hosting server coupled to a global area network; b) communicating with a second computing system physically connected to the virtual network hosting server through a second firewall, wherein the communicating step includes communicating through a direct logical connection between the computing systems. The computer program product having a computer readable medium carrying program instructions for forming a virtual network when executed using two or more computing systems each coupled to a global area network through a firewall, the executed program instructions executing a method, the method including a) establishing a physical connection between a first computing system through a first firewall to a virtual network hosting server coupled to a global area network; b) establishing a physical connection between a second computing system through a second firewall to the virtual network hosting server; and c) establishing a logical connection between the computing systems to form the virtual network.

The present invention provides a way to address and improve connectivity problems of the prior art, and the preferred embodiment provides systems, methods and computer program products to build virtual networks for TCP/IP networking to enable computing systems of different network islands to interconnect and cooperate. Additionally, the preferred embodiment provides for existing TCP/IP based applications to be seamlessly extended onto different network islands, with that extension setup dynamically across network island boundaries for diverse, independently configured islands.

### BRIEF DESCRIPTION OF THE DRAWINGS

FIG. 1 is a schematic block diagram of a network system divided into a plurality of “network islands;”

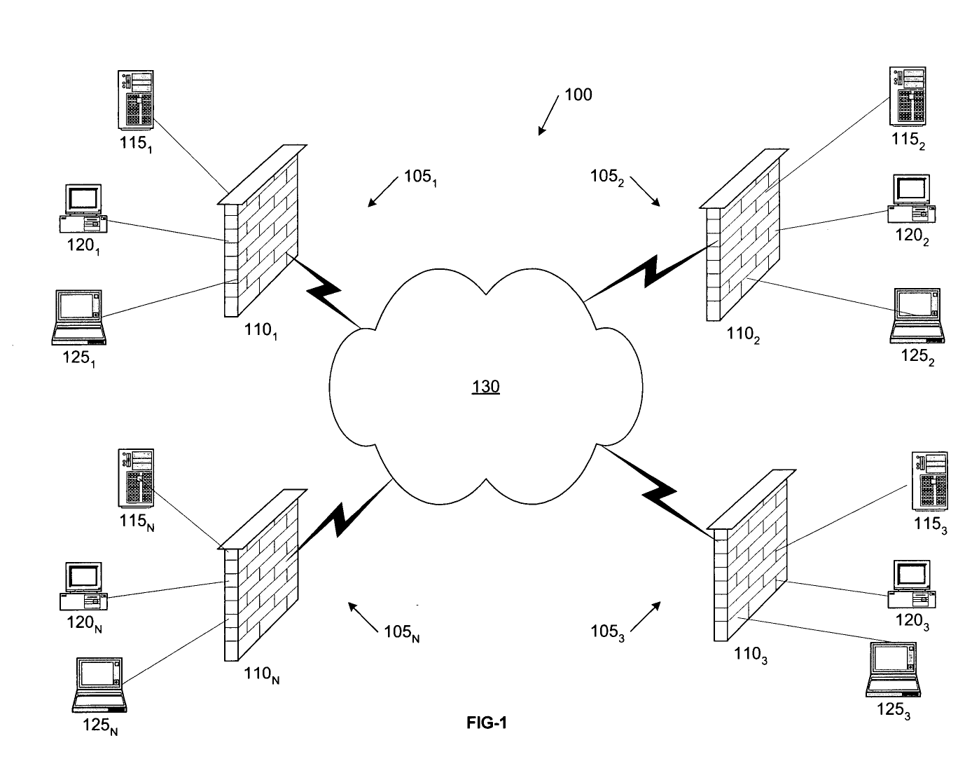

FIG. 2 is a schematic block diagram of a preferred embodiment for a virtual network system;

FIG. 3 is a schematic of a preferred embodiment for a server communication application;

FIG. 4 is a diagram illustrating a connection sequence between a client system and a host server system across a firewall permitting TCP CONNECT requests;

FIG. 5 is a diagram illustrating a connection sequence between a client system and a host server system across a firewall not permitting TCP CONNECT requests;

FIG. 6 is a flowchart diagram for detecting the applicable network environment of a client computing system;

FIG. 7 is a schematic diagram illustrating a software architecture of the communication software on a client computer system (e.g., a desktop);

FIG. 8 is a flowchart of a modified ARP process used to distinguish virtual adapters at the physical address level;

FIG. 9 is a flowchart illustrating a network ID selection process that the communication software on the client computer system uses to determine the network ID of a virtual network;

FIG. 10 is the flowchart diagram for a connection-based address translation process for incoming TCP packets passed through the virtual adapter;

FIG. 11 is the flowchart diagram for an outgoing TCP packet process applicable to packets passed through the virtual adapter; and

FIG. 12 is the flowchart diagram for a DNS name request process for handling DNS name requests issued at a client computer system.

### DESCRIPTION OF THE SPECIFIC EMBODIMENTS

The present invention relates to providing systems and methods to build virtual networks for TCP/IP networking, thereby enabling computing systems of different network islands to interconnect and cooperate. Additionally, the present invention provides a system and method for existing TCP/IP based applications to be seamlessly extended onto different network islands, with that extension setup dynamically across network island boundaries. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

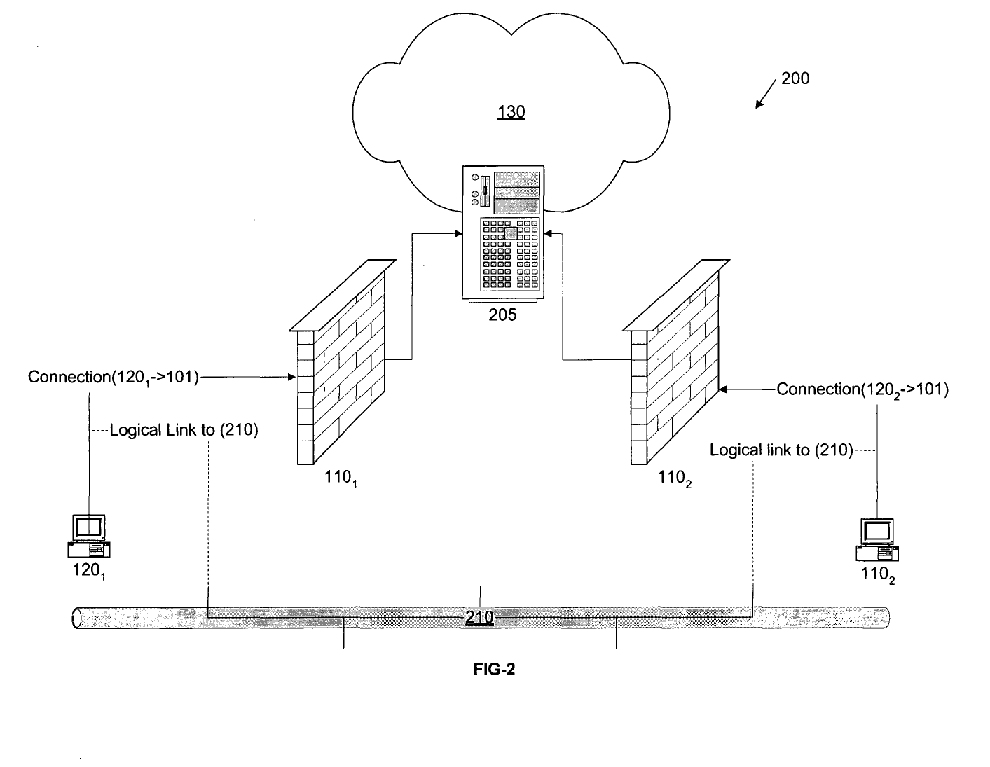

The preferred embodiments of the present invention and their advantages are best understood by referring to FIGS. 2 through 12 of the drawings.

FIG. 2 is a schematic block diagram of a preferred embodiment for a virtual network system 200. System 200 includes a virtual network hosting server 205 providing a server environment for the present invention. Similarly, computing systems of each network island 105ᵢ (e.g., computer system 120ᵢ) provide a client environment for the present invention. Each computing system 120ᵢ is connected to server 205 through a computer network 130 (e.g., Internet). This connection from 120ᵢ to network 130, due to firewall 110ᵢ, is only be an outgoing connection like any HTTP connection created from HTTP client to HTTP server. In addition, the present invention presents a method for creating firewall tunnel via standard SSL Tunneling Protocol, known as HTTP CONNECT method for the connection.

Server 205 can be any type of electronic device that is capable of accepting and establishing connections between other server computer systems and client computer systems, and also be able to exchange data through the created connections. In the embodiment shown in FIG. 2, Virtual Network Hosting Server 205 includes processor(s), memory, storage disks, operating system software, application software and communication software. Processor(s) can be any suitable processor, such as a member of the Intel Pentium family of processors. Memory can be any type of memory, such as DRAM, SRAM. Storage disks can be any type of devices that are designed for storing digital data such as hard disks, floppy disks. Operating system software can be any type of suitable operating system software that can run on the underlying hardware, such as Microsoft Windows (e.g., Windows NT, Windows 2000, Windows XP), a version of UNIX (e.g., Sun Solaris or Redhat LINUX). Application software can be of any software such as Microsoft SQL Server, Apache Web Server, a computer aided drafting application, or any other type of applications. Communication software can be any type of software that enables the data communication between server computer systems and client computer systems, the software includes the instructions that implement the server side functions for creating virtual networks specified in the present invention.

Client computer system can be any type of electronic device that is capable of establishing connection between server computer systems, and also be able to exchange data through the created connection. In the embodiment shown in FIG. 2, client computer systems (e.g., desktop 120ᵢ) includes processor(s), memory, storage disks, operating system software, application software and communication software. Processor(s) can be any suitable processor, such as a member of the Intel Pentium family of processors. Memory can be any type of memory, such as DRAM, SRAM. Storage disks can be any type of devices that are designed for storing digital data such as hard disks, floppy disks. Operating system software can be any type of suitable operating system software that can run on the underlying hardware, such as Microsoft Windows (e.g., Windows NT, Windows 2000, Windows XP), a version of UNIX (e.g., Sun Solaris or Redhat LINUX). Application software can be of any software such as Microsoft Word, Netscape Navigator, a spreadsheet application, or any other type of applications. Communication software can be any type of software that enables the data communication between the client computer system and server computer systems, the software includes the instructions that implement the client side functions for creating virtual networks specified in the present invention.

Global area computer network 130 can be any type of computer network that includes numerous computers that can communicate with one another. In some embodiments of the present invention, global area computer network is shown as Internet.

Firewalls, such as firewall 110ᵢ, can be of any hardware device or software system that enforces an access control between two networks, particularly, in some embodiments of the present invention, the two networks refer to the enterprise private network and the Global area computer network such as Internet 130.

System 200 also includes a virtual network 210 is a software implemented network object, which has the same characteristics as a physical network such as Ethernet. It appears at each client computer system as if it were another physical network interface, and at server computer systems, it appears as a software object managed by server communication software.

As described in greater detail below, the present invention provides systems and methods for building virtual network 210 on top of global area computer network, such as Internet 130.

To form virtual network 210, each participating client computer system (e.g., Desktop 120ᵢ) first establishes a connection with the server computer system (e.g., Virtual Network Hosting Server 205) that will host virtual network 210. Depending on which virtual network 210 any particular client computer system wants to participant in, server communication software associates the connection from the client computer system to its corresponding virtual network object, server communication will also manage the data exchange activities that happen on the virtual network, between each individual client computer system or broadcasting on the entire virtual network.

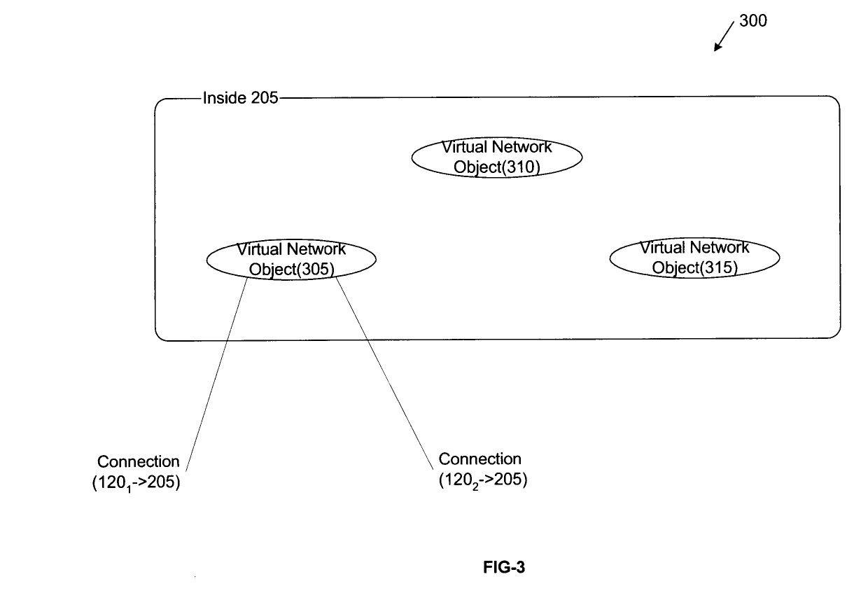

FIG. 3 is a schematic of a preferred embodiment for a server communication application 300. Application 300 includes a plurality of virtual network objects (e.g., 305, 310 and 315). In FIG. 3, one client computer system (e.g., desktop 120₁) and another client computer system (e.g., desktop 120₂) are participants to the virtual network 200 by communicating with Virtual Network Object 305 that was created by the communication software 300 on server computer system 205. Server 205, through object 305, manages virtual network 210.

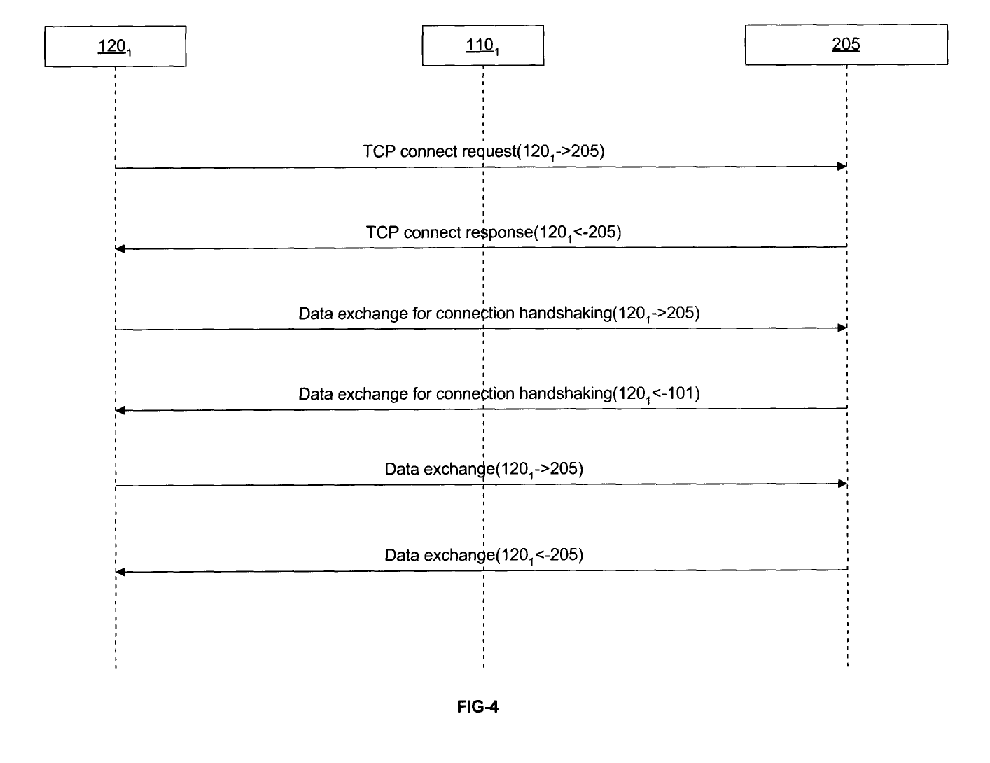

FIG. 4 is a diagram illustrating a connection sequence between a client system and a host server system across a firewall permitting TCP CONNECT requests. In the case that the firewall (e.g., firewall 110ᵢ) allows a direct outgoing connection to be created between the client computer system (e.g., desktop 120ᵢ) and the server computer system (e.g., Virtual Network Hosting Server 205), the connection is established as the sequences shown in FIG. 4.

In FIG. 4, firewall 110₁ passes the outgoing TCP CONNECT request. Therefore, desktop 120₁ directly creates a connection with Virtual Network Hosting Server 205 in the sequences shown in the figure. For such a direct TCP connection, client computer system issues the TCP CONNECT request directly to the server computer system, the firewall between the client computer system and the server computer system performs NAT (Network Address Translation) for the request and lets the TCP CONNECT pass through, similarly, the response and further data exchange will be allowed by firewall accordingly.

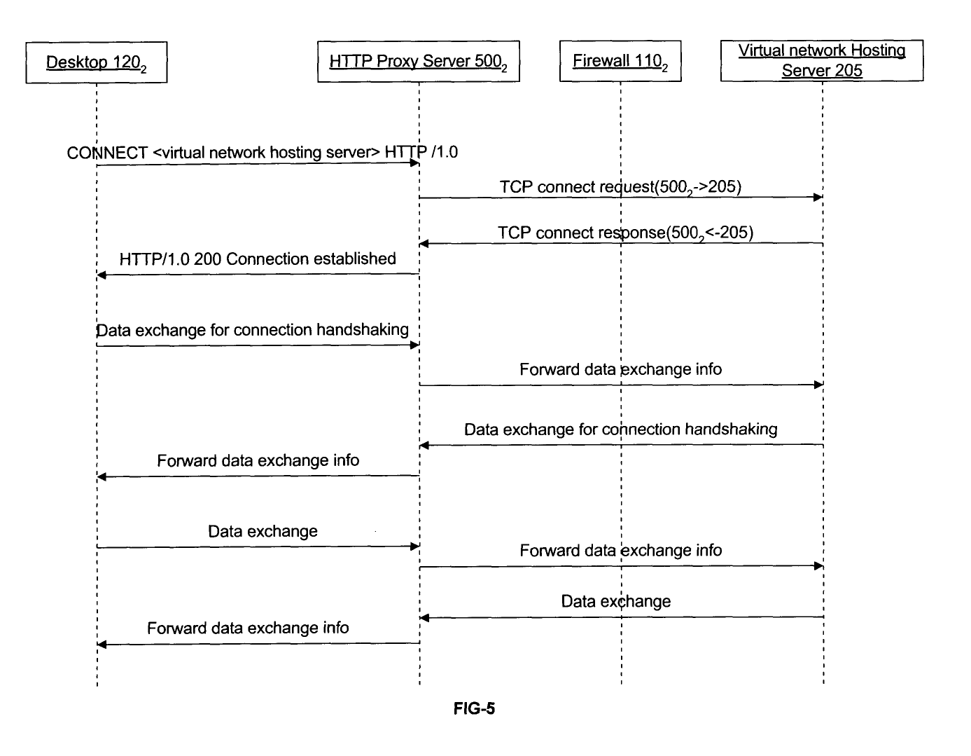

FIG. 5 is a diagram illustrating a connection sequence between a client system and a host server system across a firewall not permitting TCP CONNECT requests. In the case that the firewall (e.g., firewall 120₂) does not allow arbitrary client computer system (e.g., desktop 120₂) to connect to server computer system (e.g., Virtual Network Hosting Server 205), system 200 uses the SSL Tunneling Protocol for passing through firewall 110₂. In most cases, although firewall 110₂ does not allow arbitrary outgoing connections to be made, firewall 110₂ often allows some intermediate servers like SOCKS servers and HTTP proxy servers to make outgoing connections. FIG.5 shows the sequences for connection using SSL Tunneling Protocol. In such a case, the client computer system (desktop 120₂) does not create a direct TCP connection with the server computer system (Virtual Network Hosting Server 205), instead, the request will be forwarded by a HTTP proxy Server 500₂ using SSL Tunneling Protocol as shown in the FIG. 5. Unlike a direct connection case, the client computer system (desktop 120₂) first establishes a direct TCP connection with HTTP Proxy Server 500₂. After the TCP connection with HTTP Proxy Server 500₂ has been created, desktop 120₂ initiates the SSL tunneling request via the HTTP CONNECT method. The general syntax for tunneling requests follows:

CONNECT <host address>:<port>HTTP/1.0

. . . HTTP request headers, followed by an empty line

Once HTTP Proxy Server 500₂ receives the tunneling requests, it will eventually establish a connection with the target server and will forward data between the request client and the server in between until any one of the three parties terminates the underlying TCP connection.

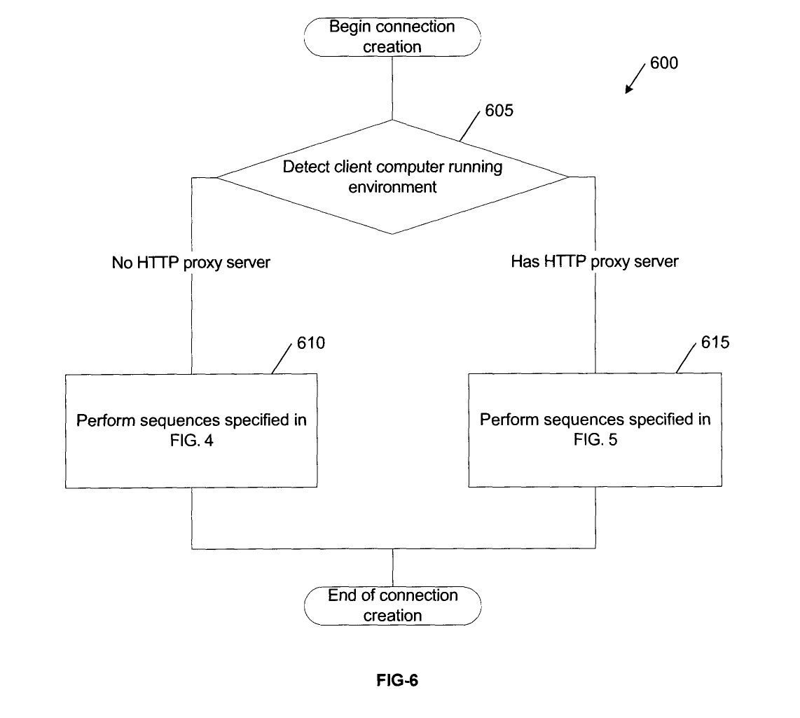

FIG. 6 is a flowchart diagram for detecting the applicable network environment of a client computing system. Due to the different connection procedures based upon the specific network environment differences of client computer systems, communication software on client computer systems detects the network environment before any attempt to request a connection to the server computer system is made. FIG. 6 gives a flow-chat diagram for a preferred detection/selection process 600.

Process 600 begins , step 605, with client communication on software (e.g., on desktop 120ᵢ) testing the applicable network environment. In the preferred embodiment, this test determines whether HTTP proxy server 500ᵢ is available. When the server is not available, process 600 advances to step 610 to implement the connection sequence shown in FIG. 4. However, if the test at step 605 determines that the server is available, process 600 advances to step 615 instead to implement the connection sequence shown in FIG. 5. Process 600 concludes after step 610 or step 615 has been performed.

As shown both in FIG. 4 and FIG. 5, after a physical connection has been established, whether it is a direct TCP connection or an indirect TCP connection via a HTTP Proxy server, the client computer system and the server computer system may perform whatever negotiation that is necessary or desirable. This negotiation may include version check, security protocol negotiation and connection authentication. The negotiation may involve multiple rounds of data exchange for the handshaking of both parties.

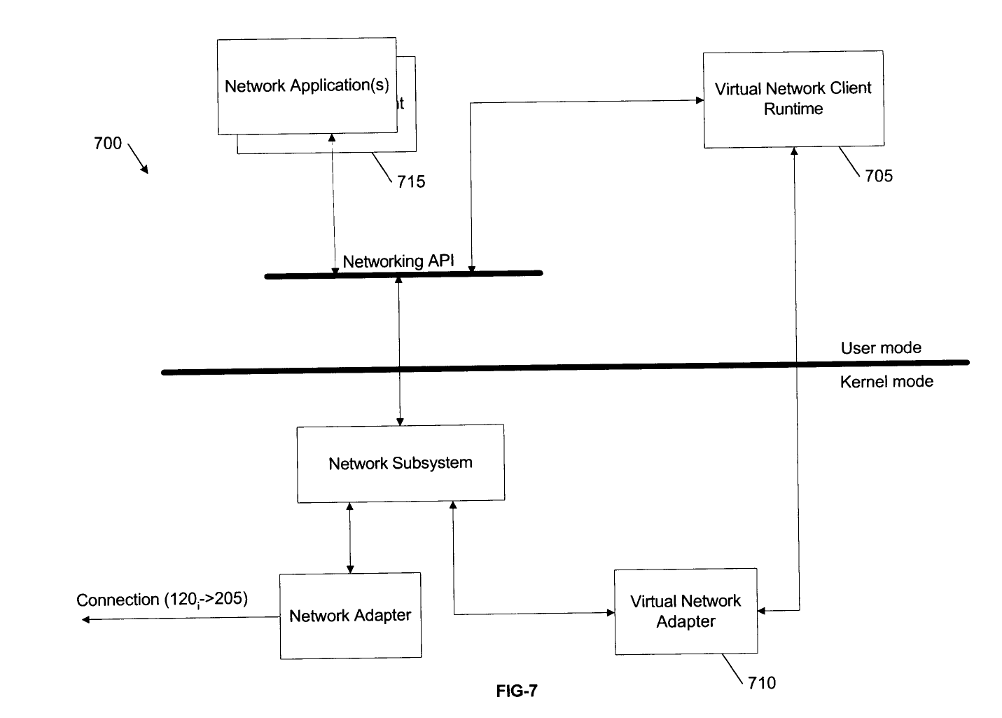

FIG. 7 is a schematic diagram illustrating a software architecture 700 of the communication software on a client computer system (e.g., desktop 120ᵢ). Architecture 700 contains two major software components, a Virtual Network Client Runtime component 705 and a Virtual Network Adapter component 710.

Virtual Network Client Runtime component 705 uses Networking services provided by the host operating system running on the client computer system to establish the connection with the server computer system (e.g., Virtual Network Hosting Server 205) and participate into the data exchange session that belongs to virtual network 200 and managed by the communication software both in the client and server computer systems.

Eventually, Virtual Network Adapter 710 will be loaded by Virtual Network Client Runtime 705, from which virtual network 200 will be presented at the client computer system. Any network applications 715 that are running on the client computer will be aware of adapter 710 and will use it just like any other physical networks that the client computer system may be attached to.

Before virtual network 200 is used, Virtual Network Adapter 710 must be configured properly. Adapter 710 has dynamic attributes for both a physical address and a logical address, complicating the configuration. The present invention provides ways to address the issues related with these two kinds of addresses.

Virtual network adapter 710 is able to simulate any physical media type, in the preferred embodiment IEEE 802.3 Ethernet is used. IEEE 802.3 Ethernet addresses are a 48-bit address, having 24 bits of vendor ID and 24 bits of serial number of the interface (assigned by the vendor), every Ethernet address is thus unique in the global context. The present invention creates virtual networks dynamically, therefore, each instantiated virtual network adapter 710 is dynamically assigned its own physical adapter addresses. Some systems do not allow dynamic changes to adapter physical addresses. To solve this, the present invention uses a pseudo physical address. Every virtual adapter 710 is statically configured with a pseudo physical address that in the preferred embodiment is the same for each adapter 710. In order to distinguish virtual adapters 710 at the physical address level, a modified Address Resolution Protocol (ARP) process is used.

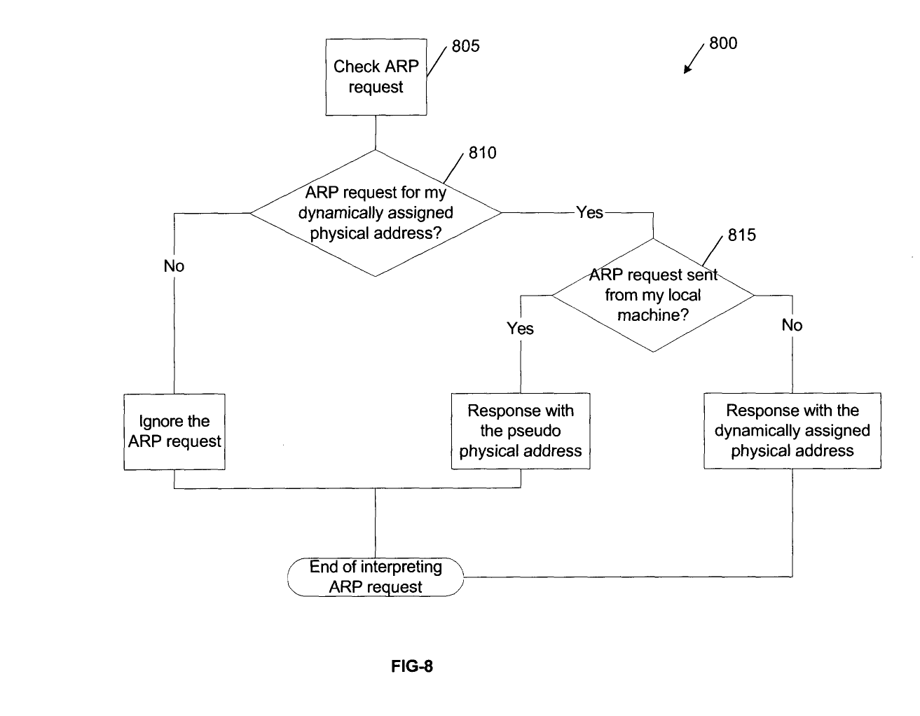

FIG. 8 is a flowchart of a modified ARP process 800 used to distinguish virtual adapters 710 at the physical address level. Every virtual adapter 710 is configured with the same pseudo physical address, however this pseudo physical address is only visible to the adapter itself, every other adapter will be viewed with its dynamically assigned physical addresses.

Process 800 begins at step 805 with the communication software in a client computer system checking packet details of each ARP (Address Resolution Protocol) request. The communications software collects all the necessary information for further actions.

Next, at step 810, process 800 checks if the ARP request is for the dynamically assigned physical address for the adapter instantiated at the client computer system. When the answer is YES, process 800 advances to step 815, otherwise process 800 ignores this ARP request.

In step 815, process 800 checks whether the ARP request was sent from the local computer system. When the ARP request was sent from the local computer system, process 800 responds with the fixed pseudo physical address, otherwise process 800 responds with the dynamically assigned physical address.

The dynamic physical address is assigned by the communication software that runs at server computer system 205, generated by combining a vendor ID and a dynamically allocated serial number that is unique in the virtual network.

Just like physical address assignments for TCP/IP networking, TCP/IP settings are configured for each virtual network adapter 710 as well. Communication software at client computer systems and server computer systems cooperate to prevent address conflict among virtual networks, and computer systems on those networks.

Client computer systems of the virtual networks may span multiple enterprise networks. Arbitration facilities that exist on individual private networks are managed differently and are unlikely to be suitable for the virtual networks. Therefore, the IP address allocation for a virtual network may have conflict problems with some private networks. The present invention provides a subnet localization method to address the this possibility.

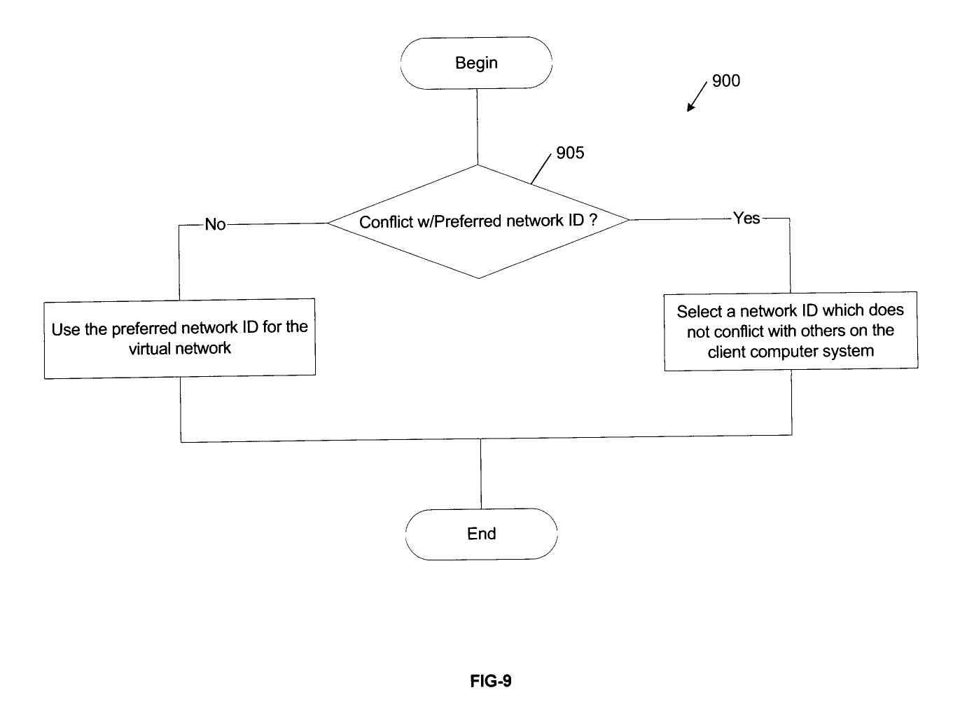

IP addresses contain two parts, a network ID portion and a host ID portion, the subnet localization method works on the network ID portion. Upon the creation of the virtual network, a preferred network ID is picked. This preferred network ID is used whenever possible once the client communication software tries to configure the TCP/IP settings for the virtual adapter. FIG. 9 is a flowchart illustrating a network ID selection process 900 that the communication software on the client computer system uses to determine the network ID of a virtual network. Process 900 includes a test step 905 to determine whether the selected preferred network ID conflicts with the local system. When a conflict does not occur, the preferred network ID may be used. When a conflict exists, the local system selects another candidate network ID, and returns to step 905 to test the candidate network ID.

When the preferred network ID is unable to be selected for a client computer system, this client computer system will have a localized view of the virtual network. A localized view means that, while other client computer systems see the virtual network with the network ID of a preferred ID, the client computer system will view the virtual network as having a network ID that is locally selected. In order to allow it to be able to communicate with others, a special process is implemented on the client communication software. For every IP packet that passes through the client systems, client communication software performs a connection-based address translation process

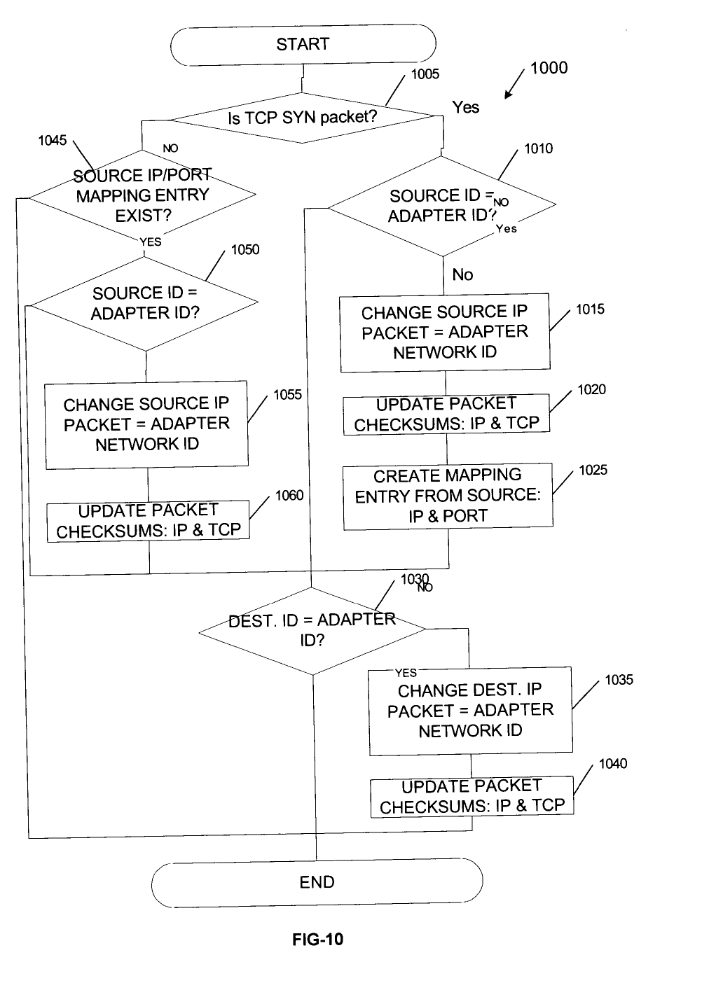

FIG. 10 is the flowchart diagram for a connection-based address translation process 1000 for incoming TCP packets passed through the virtual adapter. Process 1000 begins with step 1005 and tests whether an incoming packet is a TCP SYN packet. When it is a TCP SYN packet, process 1000 performs the steps beginning at 1010, otherwise process 1000 executes actions beginning at 1045.

At step 1010, process 1000 tests whether the network ID in the source IP address matches the network ID of the virtual adapter. When they do not match an address translation is performed as shown in step 1015 (change source ID) and step 1020 (update checksums). In addition, at step 1025, process 1000 creates a mapping entry based on the source IP and source port for later use during address translation. After completing step 1015 through step 1025 when the test at step 1010 was negative, or after step 1010 when the test is affirmative, process 1000 performs another test at step 1030. This test determines whether the destination network ID matches the network ID of the virtual adapter. When it does, process 1000 ends. When it does not match, process 1000 executes step 1035 (changes destination network ID to match the network ID of the virtual adapter) and step 1040 (updates checksums) before ending.

For TCP packets that are not SYN packets, process 1000 executes step 1045 from the test at step 1005. When a mapping entry exists for the source IP address/source port, process 1000 performs a test at step 1050, otherwise process 1000 ends.

At step 1050, process 1000 tests whether the network ID in the source IP address matches the network ID of the virtual adapter. When they do not match an address translation is performed as shown in step 1055 (change source ID) and step 1060 (update checksums). After completing step 1055 through step 1060 when the test at step 1050 was negative, or after step 1050 when the test is affirmative, process 1000 performs the steps beginning at the test of step 1030 as described above.

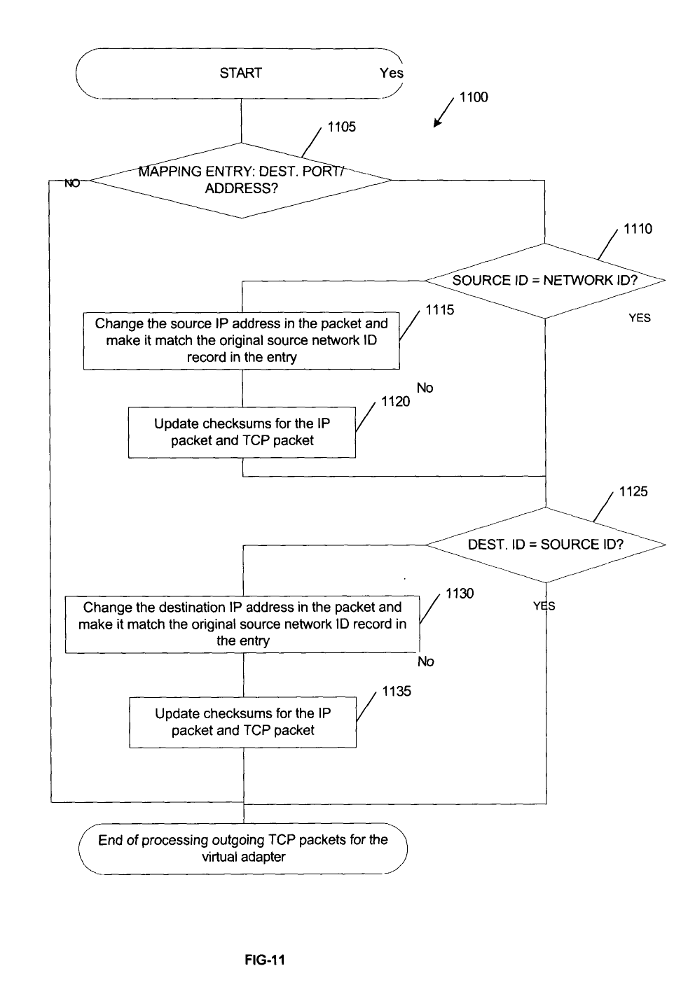

FIG. 11 is the flowchart diagram for an outgoing TCP packet process 1100 applicable to packets passed through the virtual adapter. Process 1100 tests at step 1105, for every outgoing TCP packet, whether a mapping entry exists with the information based on the destination address and the destination port in the packet. When a mapping entry is not found, process 1100 ends. When the mapping entry is found, process 1100 performs the actions starting at step 1110.

Step 1110 is a test to determine whether a network ID of the source IP address matches the original network ID record in the mapping entry. When the network ID of the source IP address does not match the original network ID record in the mapping entry, process 1100 performs address translation as specified in step 1115 (change source ID to match the original ID as set forth in the entry) and step 1120 (update checksums).

After step 1115 and step 1120, or after the test at step 1110 determines there is a match, process 1100 performs another test at step 1125 to determine whether the network ID of the destination IP address matches the original network ID record in the mapping entry. When the network ID of the destination IP address matches the original network ID record in the mapping entry, process 1100 ends.

When the network ID of the destination IP address does not match the original network ID record in the mapping entry, process 1100 performs the address translation specified in step 1130 (change destination IP address in the packet to make it match the original source network ID record in the entry) and step 1135 (update checksums). For every change in the packet, IP checksum and TCP checksum are recalculated and updated, as shown in step 1120 and step 1135 accordingly.

In addition to the assignment of IP addresses, the present invention also provides a method to implement a client-based DNS (Domain Name Service) service, so that every connected client computer system can have a DNS name that is associated with its dynamically assigned IP address. The mapping between the IP address and the associated DNS name will be performed by the communication software running at the client computer system.

To resolve a DNS name in the “non-virtual” world, two major components in the DNS system are typically involved, a DNS server and a DNR (Domain Name Resolver). The preferred embodiment works in cooperation with the DNR component. For operating system software like Windows operation system, the DNR component is designed with an open architecture allowing insertion of name service providers. By providing such a name service provider, the client communication software hosts its own name service on top of the virtual network.

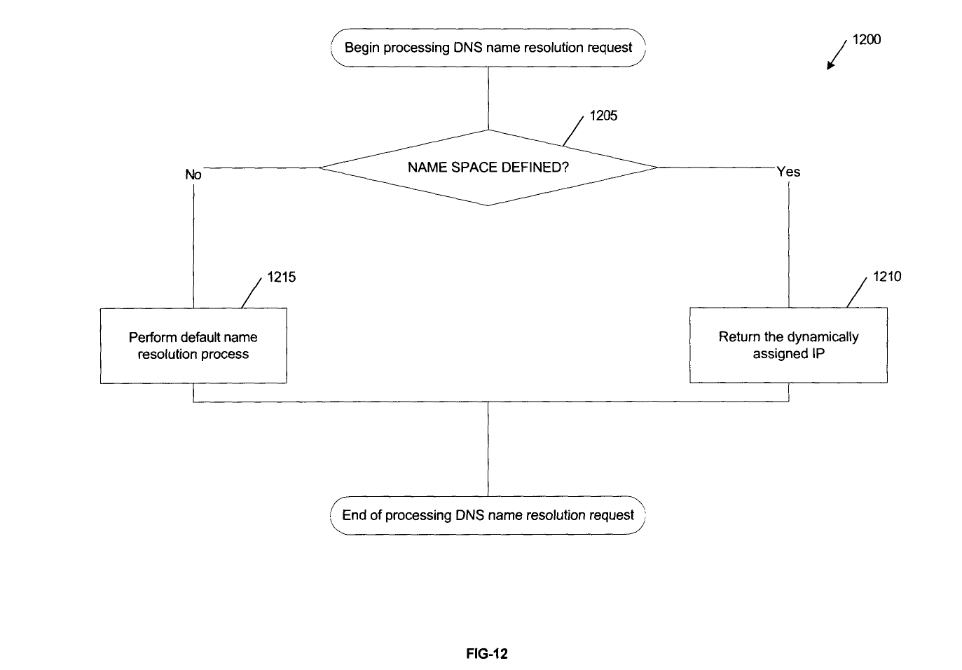

FIG. 12 is the flowchart diagram for a DNS name request process 1200 for handling DNS name requests issued at a client computer system. Process 1200 performed by the communication software at client computer system provides the name service for the virtual network. Process 1200 begins with a test (step 1205) to determine whether a name at the name space is defined for the virtual network.

When the name request matches the name space pattern defined for the virtual network, step 1210 will be performed and the dynamically assigned IP address is returned directly at client computer system, without contacting to any DNS servers. That is, the name resolution is completed totally at client machine.

When the name request does not matches the name space pattern defined for the virtual network, step 1215 will be performed, and the request will be forward to the default DNR. Therefore, an additional name space is built to supplement the regular DNS name space in this way.

One of the preferred implementations of the present invention is as a routine in an operating system made up of programming steps or instructions resident in the RAM of computer system, during computer operations. Until required by computer system, the program instructions may be stored in another readable medium, e.g. in the disk drive, or in a removable memory, such as an optical disk for use in a CD ROM computer input or in a floppy disk for use in a floppy disk drive computer input. Further, the program instructions may be stored in the memory of another computer prior to use in the system of the present invention and transmitted over a LAN or a WAN, such as the Internet, when required by the user of the present invention. One skilled in the art should appreciate that the processes controlling the present invention are capable of being distributed in the form of computer readable media in a variety of forms.

The invention has been described with reference to particular embodiments thereof. However, these embodiments are merely illustrative, not restrictive, of the invention, the scope of which is to be determined solely by the appended claims.

What is claimed is:

1. A network system, comprising:
a global area network coupled to one or more virtual network hosting servers;
a first computing system coupled to said one or more servers though a first firewall; and
a second computing system coupled to said one or more servers through a second firewall
wherein a virtual network including said computing systems is formed such that said computing systems communicate with each other through a direct logical connection.

2. The network system of claim 1 wherein said virtual network uses a physical layer connection between said one or more servers and each computing system.

3. The network system of claim 2 wherein said physical layer is established using an HTTP CONNECT command.

4. The network system of claim 1 wherein said physical layer connection includes connections to a virtual network object formed in said server.

5. A communication system using a global area network having a virtual network hosting server, comprising:
a plurality of computing systems coupled to the virtual network hosting server using the global area network; and
a plurality of firewalls, one for each computing system, for filtering network communication between a computing system and the global area network
wherein a virtual network including said computing systems is formed such that said computing systems communicate with each other through a direct logical connection.

6. A virtual network formation method, the method comprising:
a) establishing a physical connection between a first computing system through a first firewall to a virtual network hosting server coupled to a global area network;
b) establishing a physical connection between a second computing system through a second firewall to said virtual network hosting server; and
c) establishing a logical connection between said computing systems to form the virtual network.

7. The method of claim 6 wherein one of said establishing step a) and establishing step b) include:
d) issuing a TCP connect request from said computing system to said server;
e) responding to said TCP connect request from said server to said computing system;
f) exchanging connection handshake data from said computing system to said server;
g) exchanging connection handshake data from said server to said computing system; and
h) exchanging data between said computing system and said server.

8. The method of claim 6 further comprising an HTTP proxy server coupled to said first computing system in front of said first firewall wherein said establishing step a) includes:
d) issuing a proxy connect request from said first computing system to said proxy server;
e) issuing a TCP connect request from said proxy server to said server;
f) responding to said TCP connect request from said server to said proxy server;
h) responding to said TCP connect request from said proxy server to said first computing system;
g) exchanging connection handshake data from said computing system to said server through said proxy server;
g) exchanging connection handshake data from said server to said computing system through said proxy server; and
h) exchanging data between said computing system and said server through said proxy server.

9. A computer program product comprising a computer readable medium carrying program instructions for forming a virtual network when executed using two or more computing systems each coupled to a global area network through a firewall, the executed program instructions executing a method, the method comprising:
a) establishing a physical connection between a first computing system through a first firewall to a virtual network hosting server coupled to a global area network;
b) establishing a physical connection between a second computing system through a second firewall to said virtual network hosting server; and
c) establishing a logical connection between said computing systems to form the virtual network.

10. A virtual network communication system for a first computer system coupled to a global area network, comprising:
a network application operable using a processor of the first computer system, said network application coupled to a networking API;
a network adapter operable using said processor, for exchanging communication protocol signals between the global area network and a network subsystem, said network subsystem coupled to said networking API;
a virtual network client runtime operable using said processor of the first computer system, said network client runtime coupled to said network API; and
a virtual network adapter, operable using said processor, coupled to said runtime and to said network system.

11. The virtual network communication system of claim 10 wherein said virtual network adapter is created dynamically during operation of the first computer system.

12. The virtual network communication system of claim 11 wherein said virtual network adapter is assigned its own physical adapter address.

13. The virtual network communication system of claim 11 wherein said virtual network adapter is statically configured with a pseudo physical address.

14. The virtual network communications system of claim 13 wherein said virtual network adapter has an address that matches an address of a second virtual network adapter of a second computer system logically connected to said virtual network adapter of the first computer system through a virtual network hosting server.

15. The virtual network communications system of claim 14 wherein the first computer system includes a modified address resolution protocol (ARP) process.

16. The virtual network communications system of claim 15 wherein said modified ARP process returns one of said pseudo physical address and a dynamically assigned physical address depending upon a source of an ARP request for a physical address request of the first computer system.

17. An address resolution protocol (ARP) request response process for a virtual network adapter provided in a first computer system, the method comprising:
a) responding to the ARP request with a pseudo physical address of the virtual network adapter when the ARP request is sent from the first computer system; and
b) responding to the ARP request with a dynamically assigned physical address of the virtual network adapter when the ARP request is not sent from the first computer system.

18. A network system, comprising:
a global area network coupled to one or more virtual network hosting servers; and
a first computing system coupled to said one or more servers though a first firewall
wherein a virtual network including said first computing system is formed with a second computing system coupled to said one or more servers through a second firewall such that said computing systems communicate with each other through a direct logical connection.

19. A method for forming a virtual network, the method comprising:
a) establishing a physical connection between a first computing system through a first firewall to a virtual network hosting server coupled to a global area network;
b) communicating with a second computing system physically connected to said virtual network hosting server through a second firewall
wherein said communicating step includes communicating through a direct logical connection between said computing systems.

20. A method for forming a virtual network, the method comprising:
a) establishing a physical connection between a virtual network hosting server coupled to a global area network and each of a plurality of computing systems separated from said global area network by a plurality of firewalls, each one of said plurality of firewalls associated with a corresponding one of each of said plurality of computing systems; and
b) communicating between each computing system of said plurality of computing systems using a direct logical connection between them to form a virtual network of said plurality of computing systems.

21. A subnet localization method for each of a plurality of computing systems, each computing system physically coupled to a virtual network hosting server through a firewall and having a virtual network adapter, the plurality of computing systems and the hosting server defining a virtual network having a direct logical connection between the computing systems, the method comprising:
a) configuring TCP/IP settings for each virtual adapter including a combination of a common network ID and a host ID portion except for one or more virtual adapters having a conflict;
b) configuring TCP/IP settings for each of said conflicted one or more virtual adapters including a combination of an alternate network ID and a host ID portion; and
c) performing a connection-based address translation of IP packets passing through said virtual adapters
wherein all the computing systems are logically connected together into a single virtual network.

22. The subnet localization method of claim 21 wherein said address translation step c) for an IP packet coming into one of the virtual adapters comprises:
c1) testing whether a network ID in a source address portion of the IP packet matches a network ID of the one virtual adapter; and
c2) changing said network ID in said source address portion to match said network ID of said one virtual adapter when said testing step c1) is false;
c3) updating packet checksums for the IP packet when said testing step c1) is false; and
c4) creating a mapping entry based upon a source IP and a source port when said testing step c1) is false.

23. The subnet localization method of claim 21 wherein said address translation step c) for an IP packet coming into one of the virtual adapters comprises:
c1) testing whether a network ID in a destination address portion of the IP packet matches a network ID of the one virtual adapter; and
c2) changing said network ID in said destination address portion to match said network ID of said one virtual adapter when said testing step c1) is false; and
c3) updating packet checksums for the IP packet when said testing step c1) is false.

24. The subnet localization method of claim 21 wherein said address translation step c) for an IP packet transmitted from one of the virtual adapters comprises:
c1) testing whether a mapping entry exists for the destination address and the destination port;
c2) testing whether a network ID in a source address portion of the IP packet matches a network ID of the one virtual adapter when the testing step at c1) is true;
c3) changing said network ID in said source address portion to match a network ID of said mapping entry when said testing step c1) is true and said testing step c2) is false; and
c3) updating packet checksums for the IP packet when said testing step c1) is true and said testing step c2) is false.

25. The subnet localization method of claim 21 wherein said address translation step c) for an IP packet transmitted from one of the virtual adapters comprises:
c1) testing whether a mapping entry exists for the destination address and the destination port;
c2) testing whether a network ID in a destination address portion of the IP packet matches a network ID of the one virtual adapter when the testing step at c1) is true;
c3) changing said network ID in said destination address portion to match a network ID of said mapping entry when said testing step c1) is true and said testing step c2) is false; and
c3) updating packet checksums for the IP packet when said testing step c1) is true and said testing step c2) is false.

26. A domain name service (DNS) handling method for a computer system of a virtual network, the computer system having a virtual adapter, the method comprising:
a) testing, at the computer system, whether a name request at a name space for the computer system is defined for the virtual network;
b) returning a dynamically assigned IP address of the virtual adapter responsive to said name request when the testing step a) is true; and
c) forwarding said name request to a default domain name resolver (DNR) for the computer system when the testing step a) is false.
